(19) United States
(12) Patent Application Publication
(10) Pub. No.: US 2026/0227856 A1
(43) Pub. Date: Aug. 6, 2026

(54) INFORMATION PROCESSING SYSTEM, INFORMATION PROCESSING METHOD AND NON-TRANSITORY COMPUTER READABLE MEDIUM

(71) Applicant: CANON KABUSHIKI KAISHA, Tokyo (JP)

(72) Inventors: TAIHEI MUKAIDE, Kanagawa (JP); CHIHIRO NAGURA, Tochigi (JP)

(21) Appl. No.: 19/630,214

(22) Filed: Mar. 26, 2026

Related U.S. Application Data
(63) Continuation of application No. PCT/JP2024/029094, filed on Aug. 15, 2024.

(30) Foreign Application Priority Data
Oct. 6, 2023 (JP) 2023-174025

(51) Int. Cl. G06F 3/01; G10L 13/027

(52) U.S. Cl. CPC G06F 3/015; G06F 3/012; G10L 13/027

(57) ABSTRACT

An information processing system includes a processor and a memory storing a program which, when executed by the processor, causes the information processing system to a biometric information detection processing of detecting biometric information from one or more portions of a user, an estimation processing of estimating textual information or voice information from the biometric information detected by the biometric information detection processing, a determination processing of determining whether or not the biometric information corresponds to a specific movement for controlling the system, and a control processing of controlling the system on the basis of a result of the determination by the determination processing.

### CROSS-REFERENCE TO RELATED APPLICATIONS

This application is a Continuation of International Patent Application No. PCT/JP2024/029094, filed August 15, 2024, which claims the benefit of Japanese Patent Application No. 2023-174025, filed October 6, 2023, both of which are hereby incorporated by reference herein in their entirety.

### BACKGROUND

### Field of the Technology

The present invention relates to an information processing system that converts biometric information to textual information or voice information.

### Description of the Related Art

In recent years, it has been performed to recognize a spoken content by using voice information of a user. Meanwhile, it has been performed to acquire biometric information instead of the voice information, recognize a facial expression of the user, the textual information, and the like from the biometric information, and output the facial expression of the user, the textual information, and the like. Information Processing Society of Japan's Interaction 2020 "Derma: Silent Speech Interaction Using Transcutaneous Motion Sensing" (hereinafter referred to as NPL 1) discloses a technique for identifying an utterance content from biometric information related to a skin motion during a silent action by using an acceleration sensor and an angular velocity sensor.

However, in the case of NPL 1, it is necessary to, e.g., press a button in order to control a device or perform the control by using equipment connected to the device, such as a PC or smartphone, but the control cannot be performed in a situation where hands are not free with respect to such equipment. In device control by using a combination of NPL 1 and Japanese Patent Laid-Open No. 2010-21902, respective devices are necessary, and cannot be used when hand movements are not free.

### SUMMARY

The present disclosure allows easy control of a device in an information processing system that converts biometric information to textual information or voice information.

According to a first aspect of the present disclosure, an information processing system includes a processor and a memory storing a program which, when executed by the processor, causes the information processing system to execute a biometric information detection processing of detecting biometric information from one or more portions of a user; an estimation processing of estimating textual information or voice information from the biometric information detected by the biometric information detection processing; a determination processing of determining whether or not the biometric information corresponds to a specific movement for controlling the system; and a control processing of controlling the system on the basis of a result of the determination by the determination processing.

According to a second aspect of the present disclosure, an information processing method includes detecting biometric information from one or more portions of a user; estimating textual information or voice information from the biometric information detected in the detecting; determining whether or not the biometric information corresponds to a specific movement for controlling a system; and controlling the system on the basis of a result of the determination in the determining.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration of an information processing system according to an embodiment.

FIG. 2 is a flow chart illustrating an operation of the information processing system according to the embodiment.

FIG. 3 is a diagram illustrating a configuration of the information processing system according to the first example.

FIG. 4 is a schematic diagram of a detection device according to the first example.

FIG. 5 is a diagram illustrating a configuration of the information processing system according to the second example.

FIG. 6 is a schematic diagram of the detection device according to the second example.

FIG. 7 is a diagram illustrating a configuration of the information processing system according to the third example.

FIG. 8 is a schematic diagram of the detection device according to the third example.

FIG. 9 is a diagram illustrating a configuration of a contact-type sensor unit according to the third example.

FIG. 10 is a diagram illustrating the configuration of the contact-type sensor unit according to the third example.

FIG. 11 is a diagram illustrating an external force calculation procedure in the third example.

FIG. 12 is a diagram illustrating the external force calculation procedure in the third example.

### DESCRIPTION OF THE EMBODIMENTS

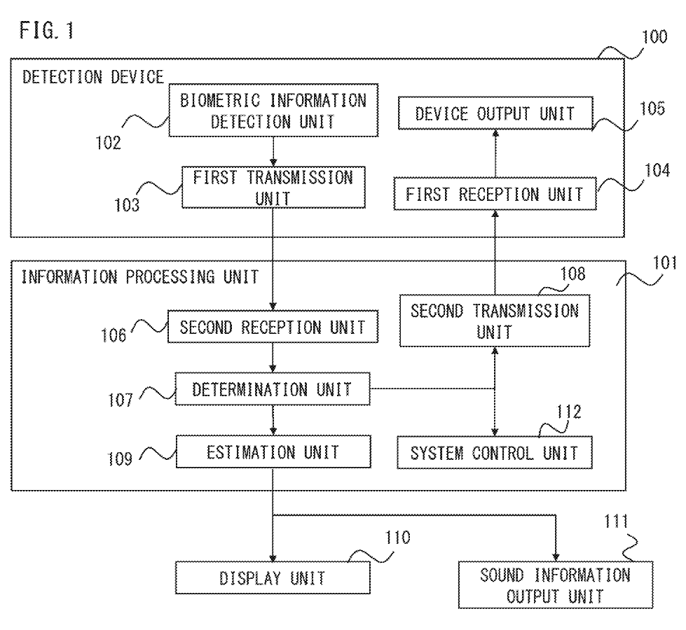

Hereinafter, embodiments of the present disclosure will be described in detail. FIG. 1 illustrates an overview of an information processing system of the present disclosure. The information processing system converts an utterance content to textual information or voice information on the basis of biometric information such as a muscle activity during vocalization. In the present disclosure, the vocalization includes an act of vocalization in which an audible sound is zero or substantially zero. In addition, for the purpose of explanation, the act of vocalization in which an audible sound is zero or substantially zero is particularly referred to as inaudible speech (silent speech) or unvoiced vocalization, and an act of vocalization that produces an audible sound of a normal level is referred to as voiced vocalization. In other words, in the present disclosure, the vocalization is a term including both the silent speech or unvoiced vocalization and voiced vocalization.

(Configuration) The information processing system according to the present embodiment is a system that estimates the utterance content (including the silent speech) of a user from the biometric information of the user. The information processing system according to the present embodiment can also be regarded as an information conversion system that converts the biometric information of the user to textual information or voice information representing the utterance content.

The information processing system according to the present embodiment mainly includes a detection device 100 that can be attached to the user, and an information processing apparatus 101 that is configured to be communicative with the detection device 100.

The detection device 100 includes a biometric information detection unit 102, a first transmission unit 103, a first reception unit 104, and a device output unit 105. The biometric information detection unit 102 detects biometric information from one or more portions of the user. The first transmission unit 103 transmits the biometric information detected by the biometric information detection unit 102 to the information processing apparatus 101. The first reception unit 104 receives a signal transmitted from the information processing apparatus 101. The device output unit 105 provides information to the user on the basis of the reception signal from the first reception unit 104.

FIG. 1 illustrates a mode in which the detection device 100 includes one biometric information detection unit, but the detection device 100 may also include two or more biometric information detection units. Note that the detection device 100 may also have a mechanism of acquiring the voice information in addition to the biometric information. In other words, the detection device 100 can also be referred to as an acquisition unit that acquires the biometric information.

The biometric information detection unit 102 is configured to include sensors for detecting biometric information related to movements of a muscle of the user, movements of the skin and tongue thereof, and the like. The biometric information detected by the biometric information detection unit 102 is, for example, biometric information related to a movement of a vocal organ of the user. The biometric information detection unit 102 includes, for example, an acceleration sensor and an angular velocity sensor that detect movements of the mouth and tongue of the user. Alternatively, the biometric information detection unit 102 may also include an acceleration sensor, an angular velocity sensor, and a myoelectric sensor that detect the movements of the mouth and tongue of the user. Still alternatively, the biometric information detection unit 102 may also include an acceleration sensor, an angular velocity sensor, and a tactile sensor that detect the movements of the mouth and tongue of the user.

The acceleration sensor detects an acceleration, and outputs data or a signal corresponding to the detected acceleration. The angular velocity sensor (gyrosensor) detects an angular velocity, and outputs data or a signal corresponding to the detected angular velocity. The tactile sensor outputs data or a signal corresponding to a force transmitted to the sensor or a direction of the force. The acceleration sensor, the angular velocity sensor, and the tactile sensor in the biometric information detection unit 102 may also be integrated with each other.

The biometric information detection unit 102 is disposed at a position where it is possible to detect the movements of the mouth and tongue of the user. For example, the biometric information detection unit 102 is disposed around the mouth of the user. Specifically, the biometric information detection unit 102 can be disposed on at least any of the lower jaw region, cheeks, periphery of the mouth, throat, subaural regions, neck region, and temples of the user. The biometric information detection unit 102 may also be disposed at a position other than the those of the above body parts as long as it is possible to detect biometric information related to the movements of the mouth and tongue.

The biometric information detection unit 102 may also include a myoelectric sensor, an ultrasonic sensor, an optical sensor, a pressure sensor, and the like. Specifically, the biometric information detection unit 102 may also include an acceleration sensor and an angular velocity sensor in which a myoelectric sensor and a pressure sensor are incorporated. Further, in the biometric information detection unit 102, a geomagnetic sensor may also be incorporated. The biometric information detection unit 102 can also acquire information related to the movement of skin and the movement of a muscle at the same position.

The acceleration sensor and the angular velocity sensor in the biometric information detection unit 102 can also detect movements of the user other than the movements of the mouth and tongue, such as a blink and a head movement.

The biometric information detected by the biometric information detection unit 102 is used for both of processing of estimating the corresponding textual information or voice information and processing of determining whether or not the detected biometric information corresponds to a specific movement for system control. In other words, the biometric information to be converted to the voice information or textual information and the biometric information for determining whether or not the biometric information corresponds to the specific movement for the system control are detected by the same sensor.

The first reception unit 104 can receive a signal from the information processing apparatus 101. The device output unit 105 outputs, to the user, any of the sound, light, and vibration according to the signal received by the first reception unit 104. The device output unit 105 may include an earphone, a light-emitting diode, a vibration element, or the like. When including the earphone, the device output unit 105 outputs a sound to the user in accordance with the signal received by the first reception unit 104. Likewise, when including the light-emitting diode or vibration element, the device output unit 105 outputs light or vibration to the user in accordance with the signal received by the first reception unit 104.

The information processing apparatus 101 is a computer including a processor, a memory, an input/output device, and a communication device. The information processing apparatus 101 functions as a second reception unit 106, a determination unit 107, a second transmission unit 108, an estimation unit 109, and a system control unit 112 through the execution of the program stored in the memory by the processor. The second reception unit 106 receives the biometric information transmitted from the detection device 100. The determination unit 107 determines whether or not the biometric information received by the second reception unit 106 is a movement set in advance. The second transmission unit 108 transmits information based on a result of the determination by the determination unit 107 to the detection device 100. The estimation unit 109 estimates the textual information or voice information corresponding to the biometric information on the basis of the received biometric information. The system control unit 112 controls the entire system on the basis of the result of the determination by the determination unit 107.

The information processing apparatus 101 is a smartphone, a personal computer (PC), a tablet PC, or the like, but is not limited thereto. The information processing apparatus 101 may also be mounted in any equipment such as a camera. When the information processing apparatus 101 is, e.g., a personal computer, the textual information estimated by the estimation unit 109 is transmitted to a display unit 110 such as a display.

The display unit 110 displays the textual information. The information processing apparatus 101 may also include a display control unit (not shown) for controlling a display mode on the display unit 110.

The estimation unit 109 estimates, from the biometric information detected by the biometric information detection unit 102, the corresponding textual information or voice information by using a predetermined estimation algorithm (conversion algorithm). The estimation unit 109 can also be expressed as a conversion unit that converts the received biometric information to the textual information or voice information. The estimation unit 109 may also estimate, on the basis of the estimated textual information, the voice information corresponding to the textual information. Alternatively, the estimation unit 109 may also directly estimate the voice information on the basis of the received biometric information.

The estimation unit 109 uses a predetermined estimation method when estimating the textual information or voice information from the biometric information detected by the biometric information detection unit 102. For the estimation method, a trained model (first trained model) with an architecture configured by using a neural network is used. The information processing apparatus 101 includes a storage unit (not shown) for storing the trained model. The estimation unit 109 has a function of performing inference by using a trained model. The trained model is a model generated using deep learning such as CNN (Convolutional Neural Network), RNN (Recurrent Neural Network), or Transformer. The trained model may be a model derived from the CNN, RNN, or Transformer, or may also be a model based on other machine learning technologies such as a support vector machine, logistic regression, a random forest, and a hidden Markov model. Alternatively, the estimation unit 109 may also perform the estimation by using a rule-based method instead of or in addition to using the trained model.

In FIG. 1, the estimation unit 109 is configured in the information processing apparatus 101. Note that the estimation unit 109 may also be configured in a cloud.

Note that the estimation unit 109 can estimate textual information or voice information of an utterance content from biometric information acquired during vocalization, i.e., during voiced vocalization and silent speech. A silent speech period refers to a period during which the user performs an act of vocalization in which an audible sound is zero or substantially zero. A voiced vocalization period refers to a period during which the user performs an act of vocalization of producing an audible sound.

The voice information estimated by the estimation unit 109 is transmitted to a sound information output unit 111. The sound information output unit 111 is a speaker, and the sound information output unit 111 can reproduce the voice information. The textual information or voice information estimated by the estimation unit 109 can also be displayed or reproduced at a destination of transfer by transferring the information to another receiver via a network or the like.

The determination unit 107 determines whether or not the biometric information detected by the biometric information detection unit 102 corresponds to any of one or a plurality of preset specific movements for controlling the system. The determination unit 107 performs the above determination according to, e.g., a determination algorithm using a trained model (second trained model) with an architecture configured by using a neural network. The information processing apparatus 101 includes a storage unit (not shown) for storing a trained model. The determination unit 107 has a function of performing estimation by using a trained model. The trained model is a model generated using deep learning such as CNN (Convolutional Neural Network), RNN (Recurrent Neural Network), or Transformer. The trained model may be a model derived from the CNN, RNN, or Transformer, or may also be a model based on other machine learning technologies such as the support vector machine, the logistic regression, the random forest, and the hidden Markov models. Alternatively, the estimation unit 109 may also perform the estimation by using a rule-based method instead of or in addition to using the trained model.

While the determination unit 107 is configured in the information processing apparatus 101 in FIG. 1, the determination unit 107 may also be configured in the detection device 100. In this case, the device output unit 105 can directly produce an output to the user depending on the determination result from the determination unit 107. Alternatively, it may also be possible to integrate the determination unit 107 and the estimation unit 109 with each other and perform the determination and estimation via a single trained model. In other words, the trained model (first trained model) to be used by the determination unit 107 and the trained model (second trained model) to be used by the estimation unit 109 may also be the same trained model.

The system control unit 112 controls the system on the basis of the determination result from the determination unit 107. More specifically, when the determination unit 107 determines that the biometric information detected from one or more portions of the user corresponds to any of the specific movements for performing the system control, the system control unit 112 performs the system control corresponding to the movement.

The "specific movement for performing the system control" (hereinafter referred to also as the "specific movement") may be any movement that can be acquired by the detection device 100, and can be, e.g., a movement different from a movement during vocalization. An example of the "specific movement" is any of the movement of the mouth, the movement of the tongue, the movement of the cheek, the movement of the eyeball or eyelid, the movement of the face, or a combination thereof. Note that the "specific movement" may also be a movement for uttering a predetermined keyword.

The "system control" may be any control as long as the system control is related to the detection device 100 or the information processing apparatus 101. An example of the "system control" is to start or end the conversion of the detected biometric information to the textual information or voice information or to specify an operation mode at the time of the conversion of the detected biometric information to the textual information or voice information. For example, when it is determined that the biometric information corresponds to the first specific movement while the estimation processing is not executed, the estimation by the estimation unit 109 is started. Meanwhile, when it is determined that the biometric information corresponds to the second specific movement while the estimation processing is executed, the estimation by the estimation unit 109 is ended. In other words, the system control unit 112 starts the estimation by the estimation unit 109 when it is determined that the biometric information corresponds to the first specific movement, and stops the estimation by the estimation unit 109 when it is determined that the biometric information corresponds to the second specific movement. Accordingly, the first specific movement serves as a signal for starting the estimation by the estimation unit 109, and the second specific movement serves a signal for stopping the estimation by the estimation unit 109. The user allows the estimation unit 109 to perform estimation control by performing either one of the first specific movement and the second specific movement.

Alternatively, depending on which one of the plurality of preset specific movements the biometric information corresponds to, the system is controlled so as to switch to the operation mode corresponding to the movement or to activate an application corresponding to the movement.

For example, the system control unit 112 starts to display the textual information by using the display unit 110 when it is determined that the biometric information corresponds to a third specific movement, and ends the display of the textual information using the display unit 110 when it is determined that the biometric information corresponds to a fourth specific movement. Alternatively, the system control unit 112 may also start to output the voice information by using the sound information output unit 111 when it is determined that the biometric information corresponds to a fifth specific movement. Still alternatively, the system control unit 112 may also end the outputting of the voice information by using the sound information output unit 111 when it is determined that the biometric information corresponds to a sixth specific movement. In other words, the system control unit 112 can control components such as the estimation unit 109, the display unit 110, and the sound information output unit 111, i.e., the system on the basis of the type of the movement based on the biometric information.

Alternatively, the information processing apparatus 101 may be configured in the cloud. In this case, the first transmission unit 103 of the detection device 100 transmits, to the cloud, the biometric information detected by the biometric information detection unit 102. The cloud performs conversion to the textual information or voice information on the basis of the biometric information, and transmits the textual information resulting from the conversion to the display unit 110. The display unit 110 displays the textual information. Alternatively, the cloud may also further convert the textual information resulting from the conversion to the voice information and transmit the voice information to the sound information output unit 111. Still alternatively, the cloud may also convert the biometric information directly to the voice information, and transmit the voice information to the sound information output unit 111.

Communication between the detection device 100 and the information processing apparatus 101 may be either wired or wireless. In the case of wired communication, the first transmission unit 103 and the first reception unit 104 in the detection device 100 are wiredly connected to the second reception unit 106 and the second transmission unit 108 in the information processing apparatus 101 via a USB cable or the like. In the case of wireless communication, the respective units mentioned above are wirelessly connected by wireless LAN communication such as the Wi-Fi or short-range wireless communication such as the Bluetooth (registered trademark).

When the information processing apparatus 101 is a smartphone or a tablet PC, the display unit 110 is a display. The sound information output unit 111 is made of a smartphone, a speaker installed in the tablet PC, or an earphone connected to the smartphone or the tablet PC.

Note that the information processing apparatus 101 can be regarded as an information conversion apparatus for converting the biometric information detected by the biometric information detection unit 102 to the textual information or voice information. The information processing apparatus 101 can also be regarded as an information estimation apparatus for estimating the textual information or voice information from the biometric information detected by the biometric information detection unit 102. Furthermore, the information processing apparatus 101 can also include a processing unit that evaluates the biometric information detected by the biometric information detection unit 102 on the basis of a predetermined evaluation criterion, and deletes the textual information or voice information corresponding to the biometric information that does not meet the predetermined evaluation criterion.

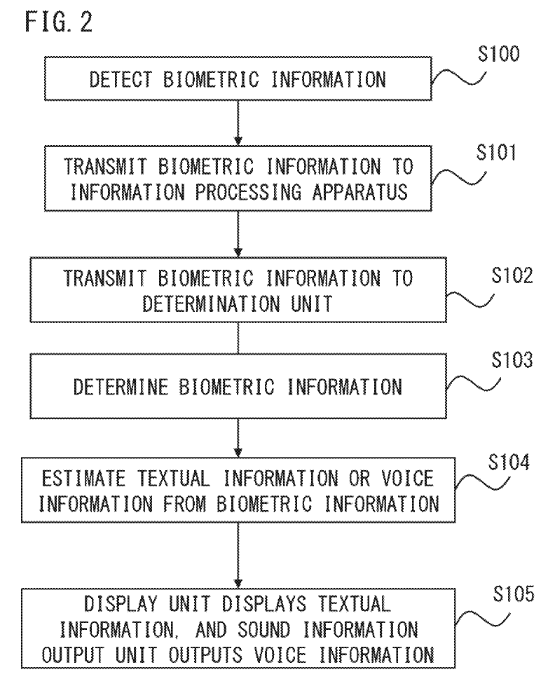

(Processing) FIG. 2 illustrates a flow chart showing a flow of an information processing method to be implemented by the information processing system according to the present embodiment.

Step S100: The user attaches the detection device 100 to a position where the biometric information detection unit 102 can detect biometric information. The user attaches the detection device 100 to the head region, the neck region, the periphery of the head region or neck region, or the like. The biometric information detection unit 102 detects biometric information including acceleration information and angular velocity information or the acceleration information and angular velocity information including at least one of a myoelectric signal, tactile information, and the like.

Step S101: The first transmission unit 103 transmits the biometric information to the information processing apparatus 101. Accompanying information related to time period information (time information) has been added to the biometric information. The first transmission unit 103 can transmit the biometric information and the time period information to the information processing apparatus 101.

Step S102: The biometric information detected by the detection device 100 is received by the second reception unit 106 of the information processing apparatus 101. The second reception unit 106 transmits the received biometric information to the determination unit 107.

Step S103: The determination unit 107 determines, according to a predetermined determination algorithm, whether the biometric information corresponds to a preset specific movement (including a case where the mouth has not been moved for a predetermined period of time). When it is determined that the biometric information indicates a movement corresponding to the start of the conversion, the system control unit 112 transmits a signal to the device output unit 105 via the second transmission unit 108 and via the first reception unit 104 of the detection device 100, and the device output unit 105 produces a sound to notify the user of the start of the conversion. The system control unit 112 also performs control so as to start the estimation of subsequently acquired biometric information by the estimation unit 109. Meanwhile, after the start of the estimation, when the determination unit 107 determines that the biometric information indicates a state where the mouth has not been moved for a predetermined period of time, the system control unit 112 performs control so as to end the estimation by the estimation unit 109.

Step S104: The estimation unit 109 estimates textual information, voice information, or command information from the biometric information according to a predetermined estimation algorithm. Alternatively, the estimation unit 109 may also estimate the voice information from the biometric information, or may estimate the textual information and then perform voice synthesis to convert the textual information to the voice information. The estimation unit 109 outputs information estimated from the biometric information.

Step S105: The display unit 110 displays the textual information estimated by the estimation unit 109. The sound information output unit 111 outputs the voice information obtained by further converting the textual information estimated by the estimation unit 109.

The textual information estimated by the estimation unit 109 can be stored in the storage unit of the information processing apparatus 101. The textual information can also be transferred via a network and displayed on an external terminal.

Through the conversion of the textual information to the voice information, it is possible to reproduce and record the voice information at the external terminal, while the user can also listen to the reproduced voice via an earphone. This allows the user to confirm whether or not the estimation is correct. In addition, it is also possible for the voice information to be transferred via the network, and reproduced and recorded at another external terminal. By repeating such a sequential flow, continuous communication using the biometric information becomes possible.

The information processing system according to the present embodiment allows the user to perform hands-free system control by moving his or her mouth, face, cheek, or the like, and is highly convenient for the user. In addition, since the information processing system according to the present embodiment determines the specific movements for the system control by using the biometric information to be used for voice recognition, it is not necessary to use a separate biometric information detection device for the system control. This saves the need for the user to use an additional device, improves convenience, and can also reduce the cost of a product.

### First Example

Next, an information processing system according to the first example will be described. The information processing system according to the present example converts sensing data (biometric information) obtained by using acceleration and angular velocity sensors that are attached to the cheek and subaural region of a user to textual information or voice information.

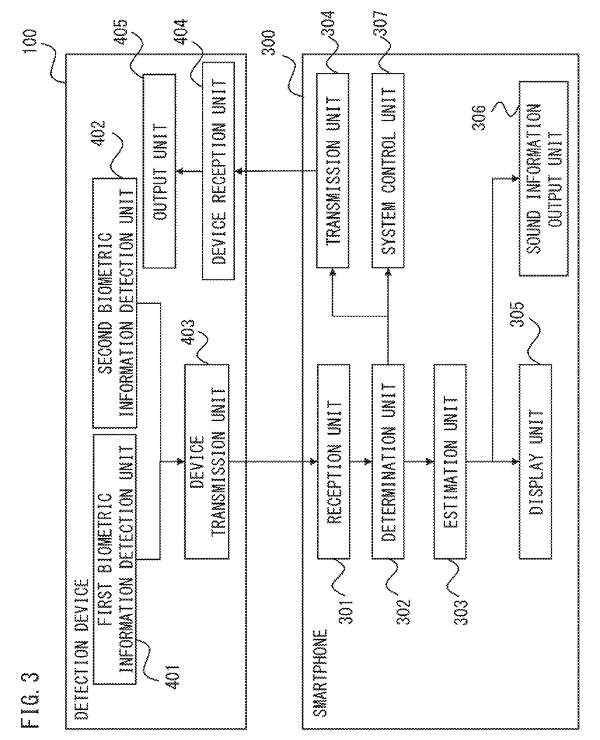

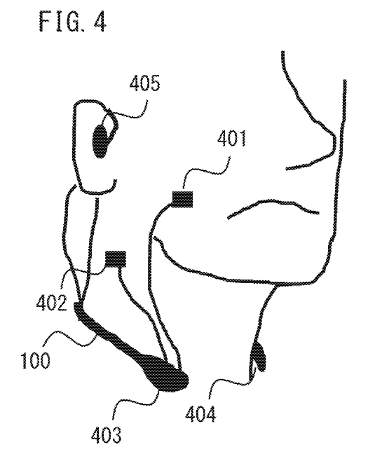

FIG. 3 illustrates an overview of the information processing system according to the present example, and FIG. 4 illustrates a schematic diagram of the detection device 100 according to the present example. Here, a mode in which the information processing apparatus of the information processing system is a smartphone 300. The detection device 100 is supplied with power from a battery (not shown).

As shown in FIG. 4, the user wears the detection device 100 around the neck region. The detection device 100 is a neckband type that is worn around the neck region of the user. The detection device 100 is configured to include a first biometric information detection unit 401, a second biometric information detection unit 402, a device transmission unit 403, a device reception unit 404, and an output unit 405. To the device transmission unit 403, the first biometric information detection unit 401 and the second biometric information detection unit 402 are connected by wire. The device transmission unit 403 can transmit the biometric information detected by the first biometric information detection unit 401 and the second biometric information detection unit 402 to the outside.

Each of the first biometric information detection unit 401 and the second biometric information detection unit 402 is a 6-axis acceleration/angular velocity sensor. The 6-axis acceleration/angular velocity sensor is a sensor capable of measuring, e.g., a 3-axis translational acceleration and a 3-axis angular acceleration.

The first biometric information detection unit 401 and the second biometric information detection unit 402 are respectively attached to the cheek and the subaural region of the user via, e.g., a self-adhesive gel. This allows the first biometric information detection unit 401 and the second biometric information detection unit 402 to detect the biometric information (such as the acceleration and angular velocity). Thus, the first biometric information detection unit 401 and the second biometric information detection unit 402 can detect information related to movements of the body parts of the user.

The biometric information detected by the first biometric information detection unit 401 and the second biometric information detection unit 402 is transmitted by the device transmission unit 403 to, e.g., the Wi-Fi connected smartphone 300. The reception unit 301 in an application of the smartphone 300 receives data.

The determination unit 302 determines, by using a trained model, whether or not the data received by the reception unit 301 is biometric information corresponding to a specific movement or a situation where the mouth has not moved for 1 second. An example of the specific movement can be a movement of closing the eyes continuously for 0.5 seconds or longer. When determining that the received data is the biometric information corresponding to the movement of closing the eyes for 0.5 seconds or longer, the determination unit 302 transmits the information to the device reception unit 404 via the transmission unit 304. The output unit 405 gives a sound signal to the user that the subsequent biometric information will be converted. After hearing the sound, the user performs silent vocalization with the intent to convert the biometric information to be able to estimate the biometric information. Meanwhile, after the start of the estimation, when it is determined that the data received by the determination unit 302 indicates a state where the mouth has not moved for 1 second or longer after the start of the estimation, it is determined that data acquisition for the estimation has been completed, and the biometric information is not transmitted to the estimation unit 303 until the start of the next estimation is determined.

The determination processing in the determination unit 302 is determined on the basis of the trained model. For the generation of the trained model in the present example, biometric information in 20 types of movements set in advance, such as a movement of closing the eyes for 0.5 seconds or longer, was acquired 30 times from five users for each of the movements. Here, 80% of all data was used as training data, while the remaining 20% thereof was used as evaluation data. For the training, the training data was used to train a neural network 500 epochs by using individual movements to which serial numbers were assigned as a correct label, thus producing the trained model.

The estimation unit 303 inputs the biometric information received by the reception unit 301 to the trained model, and estimates the corresponding textual information or voice information. Specifically, by using a total of 12-axis sensor information from the 6-axis×2 acceleration/angular velocity sensor as input data to the trained model, the textual information or voice information is estimated.

When the determination unit 302 determines that the biometric information detected from one or more portions of the user corresponds to any of the specific movements for performing the system control, the system control unit 307 performs the system control corresponding to the movement.

For the generation of the trained model in the present example, biometric information during silent vocalization was acquired for 5,000 sentences from five users. Here, 80% of all data was used as training data, while the remaining 20% thereof was used as evaluation data. For the training, the training data was used to train a neural network 2000 epochs by using sentences converted to phonemes as a correct label, thus producing the trained model. The estimation unit 303 has a function of estimating textual information including Chinese characters and Hiragana characters from an estimated phoneme string. The estimation unit 303 also has a function of estimating the voice information from the phoneme string.

The character information estimated (resulting from the conversion) by the estimation unit 303 is displayed on a display, which is the display unit 305 of the smartphone. The sound information output unit 306 reproduces the voice information estimated (resulting from the conversion) by the estimation unit 303.

### Second Example

Next, an information processing system according to the second example will be described. The information processing system according to the present example converts sensing data (biometric information) obtained by using acceleration and angular velocity sensors and myoelectric sensors which are attached to the cheeks and lower jaw region of a user to textual information or voice information.

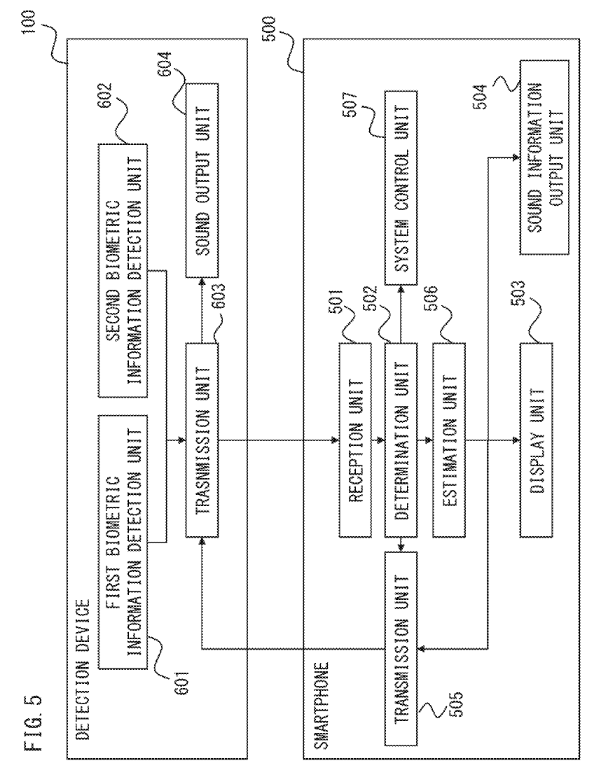

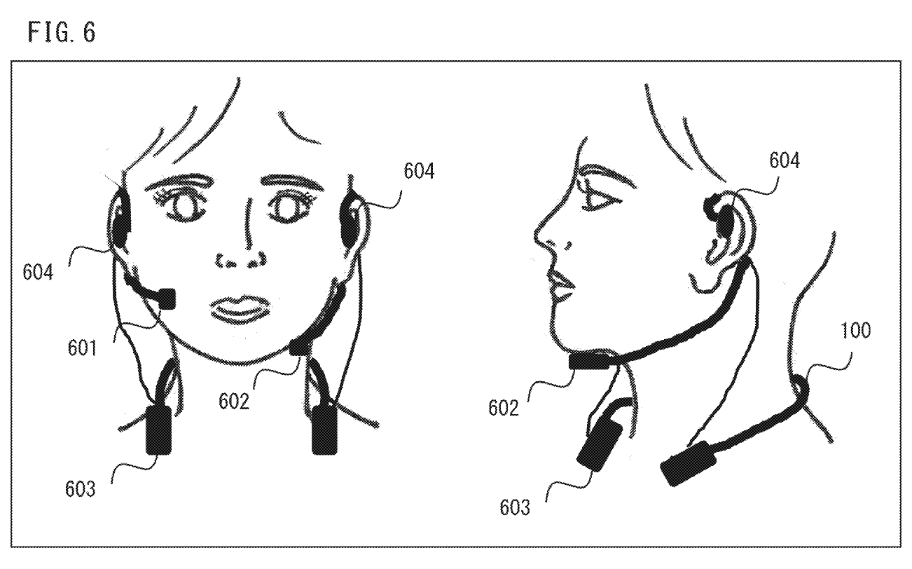

FIG. 5 illustrates an overview of the information processing system according to the present example, and FIG. 6 illustrates a schematic diagram of the detection device 100 according to the present example. Here, a mode in which the information processing apparatus of the information processing system is a smartphone 500. The detection device is supplied with power from a battery (not shown).

As shown in FIG. 6, the user wears the detection device 100 around and in his or her neck region and ears. The detection device 100 is configured to include a neck-band portion that is worn around the neck region of the user, and earphone portions. The neckband portion and the earphone portions are connected by wire. The detection device 100 may also be provided with a connecting portion that connects both ends of a stretchable member in order to be worn around the neck region of the user. The detection device 100 is configured to include a first biometric information detection unit 601, a second biometric information detection unit 602, a transmission/reception unit 603, and sound output units 604. To the transmission/reception unit 603, the first biometric information detection unit 601, the second biometric information detection unit 602, and the sound output units 604 are connected. The transmission/reception unit 603 can transmit the biometric information detected by the first biometric information detection unit 601 and the second biometric information detection unit 602 to the outside. In addition, the transmission/reception unit 603 can receive, via the transmission unit 505, the information determined by the determination unit 502 and the information resulting from the conversion by the estimation unit 506.

Each of the first biometric information detection unit 601 and the second biometric information detection unit 602 integrally includes a 6-axis acceleration and angular velocity sensor and a myoelectric sensor. The 6-axis acceleration and angular velocity sensor is capable of measuring, e.g., a 3-axis translational acceleration and a 3-axis angular acceleration. As an electrode of the myoelectric sensor, a 3-pole Ag electrode is used. In other words, each of the first biometric information detection unit 601 and the second biometric information detection unit 602 is configured to include the plurality of different sensors.

The first biometric information detection unit 601 and the second biometric information detection unit 602 are respectively pressed against the cheek and lower jaw region of the user by respective support members extending from the sound output units 604. In order to further improve wearability, for example, the first biometric information detection unit 601 and the second biometric information detection unit 602 may also be adhered via a self-adhesive gel. Thus, the first biometric information detection unit 601 and the second biometric information detection unit 602 can detect the biometric information (various accelerations and myoelectric). This allows the first biometric information detection unit 601 and the second biometric information detection unit 602 to detect information related to the movements of the body parts of the user.

The biometric information detected by the biometric information detection units 601 and 602 is transmitted by the transmission/reception unit 603 to, e.g., the Wi-Fi connected smartphone 500. A reception unit 501 in the application of the smartphone 500 receives data.

The determination unit 502 determines, by using the trained model, whether or not the biometric information received by the reception unit 501 is biometric information corresponding to a specific movement or a situation where the mouth has not moved for 1 second. An example of the specific movement can be a nodding motion, i.e., a vertical head motion by the user or a motion of continuously closing the eyes for 0.5 seconds or longer by the user. When the determination unit 502 determines that the user has nodded, the smartphone 500 transmits a result of the determination from the transmission unit 505 to the transmission/reception unit 603, and the detection device 100 produces a sound using the sound output units 604 to notify the user of the start of a command input mode. Meanwhile, when the determination unit 502 determines that the user has closed his or eyes for 0.5 seconds or longer, the smartphone 500 transmits a result of the determination from the transmission unit 505 to the transmission/reception unit 603, and the detection device 100 produces a sound using the sound output units 604 to notify the user of the start of a direct conversion mode. The movements related to the determination of such modes have been set in advance, and may also be movements other than these. The determination unit 502 determines a subsequent conversion mode on the basis of the result of the determination. Meanwhile, after the start of the conversion, when it is determined that the data received by the determination unit 502 indicates a state where the mouth has not moved for 1 second or longer, it is determined that data acquisition for the conversion has been completed, and the biometric information is not transmitted to the estimation unit 506 until the start of the next conversion is determined.

The determination processing in the determination unit 502 is performed on the basis of the trained model. For the generation of the trained model in the present example, biometric information in 20 types of movements set in advance, such as a nodding motion, was acquired 30 times from five users for each movement. Here, 80% of all data was used as training data, while the remaining 20% thereof was used as evaluation data. For the training, the training data was used to train a neural network 500 epochs by using individual movements to which serial numbers were assigned as a correct label, thus producing the trained model.

When it is determined by the determination unit 502 that the biometric information detected from one or more portions of the user corresponds to any of the specific movements for performing the system control, the system control unit 507 performs the system control corresponding to the movement.

The estimation unit 506 inputs the biometric information received by the reception unit 501 to the trained model, and estimates the corresponding textual information or voice information. For example, when the operation mode is the direct conversion mode, the textual information or voice information corresponding to an utterance content of the user is estimated from the received biometric information.

For the generation of the trained model in the present example, biometric information during silent vocalization was acquired for 5,000 sentences from five users. Of all data, 80% was used as training data, and the remaining 20% was used as evaluation data. For the training, the training data was used to train a neural network 2000 epochs by using sentences converted to phonemes as a correct label, thus producing the trained model.

In the case of the direct conversion mode, the content estimated by the estimation unit 506 is converted from phoneme information to textual information to be displayed on a display, which is a display unit 503 of the smartphone. A sound information output unit 504 reproduces the voice information from the phoneme information estimated by the estimation unit 506. Alternatively, it is also possible that the voice information estimated by the estimation unit 506 is transmitted by using the transmission unit 505 to the device, received by the transmission/reception unit 603 of the device, and reproduced by the sound output units 604. Meanwhile, in the case of the command input mode, the estimated content serves as a control command for the smartphone. For example, when the estimated content is "display a mail", the content of a new incoming mail recorded in the smartphone is displayed on the display unit 503. Meanwhile, when the estimated content is "read a mail", the content of the new incoming mail recorded in the smartphone is voice-synthesized and output from the sound information output unit 504 or the sound output units 604.

### Third Example

Next, an information processing system according to the third example will be described. The information processing system according to the present example converts sensing data (biometric information) obtained by using acceleration and angular velocity sensors attached to the cheek and lower jaw region of a user and contact-type sensors to textual information or voice information.

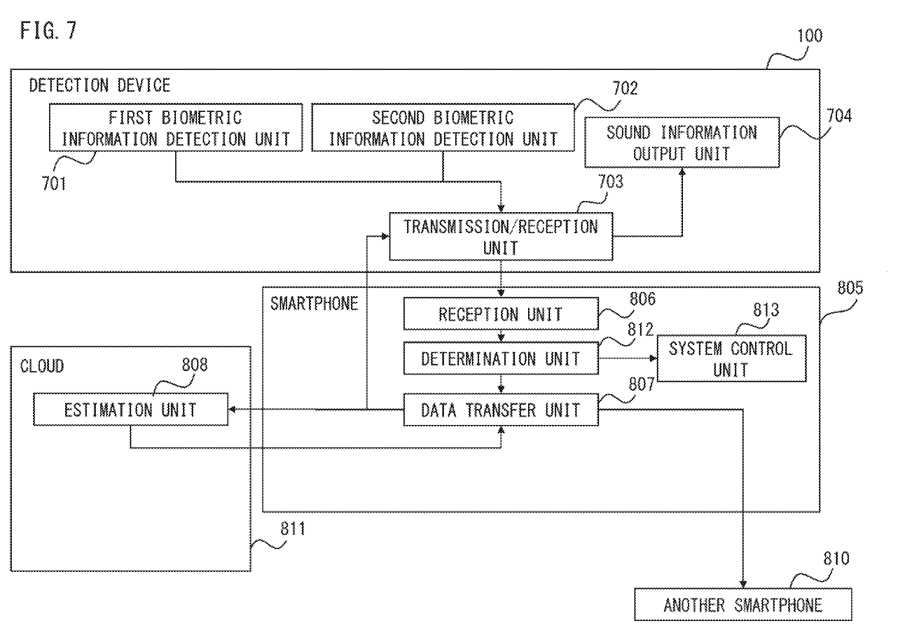

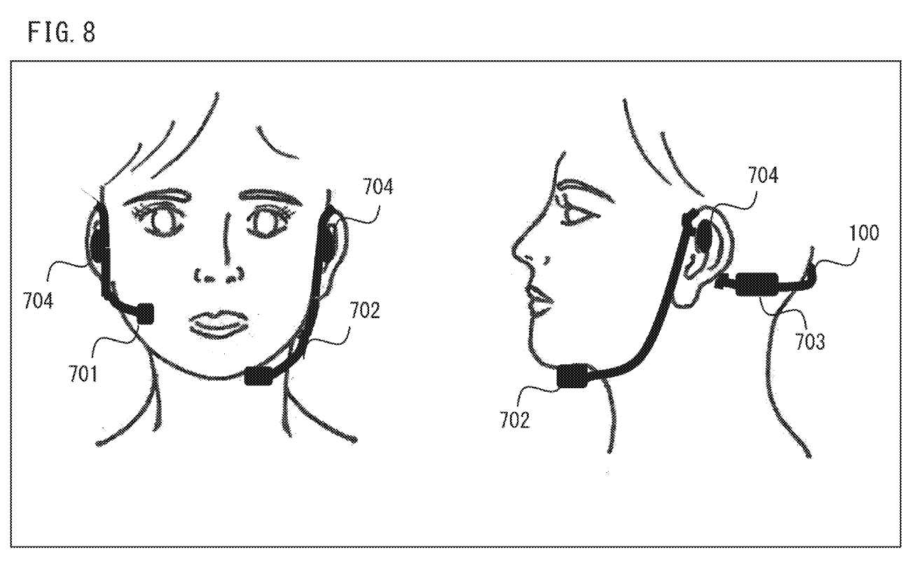

FIG. 7 illustrates an overview of the information processing system according to the present example, and FIG. 8 illustrates a schematic diagram of the detection device 100.

The detection device 100 is a headset type that is attached to ears of the user. The detection device 100 is configured to include a first biometric information detection unit 701, a second biometric information detection unit 702, a transmission/reception unit 703, and sound information output units 704. Each of the first biometric information detection unit 701 and the second biometric information detection unit 702 is configured of a contact-type sensor unit.

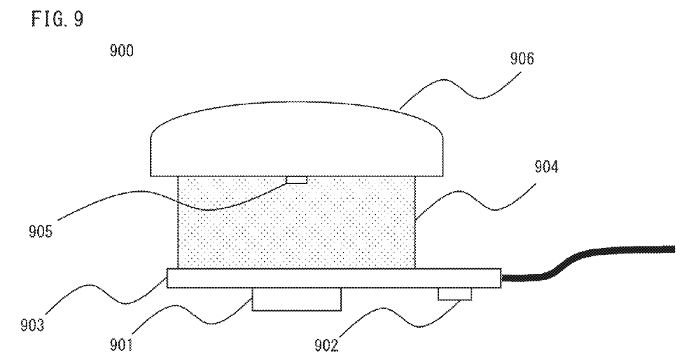

FIG. 9 is a diagram illustrating a configuration of a contact-type sensor unit 900 used in the present example.

The sensor unit 900 is configured to include a circuit board 903 on which a magnetic sensor IC 901 and an inertia sensor IC 902 are mounted, an elastic member 904, a permanent magnet 905, and a contact member 906. The inertia sensor IC 902 has an embedded detection unit for a 3-axis acceleration and a 3-axis angular velocity. The contact member 906 is a member that comes into contact with skin.

Between the circuit board 903 and the contact member 906, the elastic member 904 is provided. The elastic member 904 can be deformed by an external force applied between the contact member 906 and the circuit board 907. As the elastic member 904, a soft material such as silicon gel, synthetic rubber, or sponge can be used, or a metal or resin spiral spring or the like can also be used.

On the contact member 906 side of the elastic member 904, the permanent magnet 905 is fixed. The magnetic sensor IC 901 detects a relative displacement with respect to the permanent magnet 905. The magnetic sensor IC 901 is an element having four magnetic field detection points therein. As the magnetic sensor IC 901, a 3-axis geomagnetic sensor capable of detecting the direction of a magnetic field vector may also be used. The sensor unit 900 uses an output from the magnetic sensor IC 901 to detect a three-dimensional displacement of a magnet by using a subsequent signal processing circuit (not shown), and calculate an external force on the basis of the detected amount of displacement.

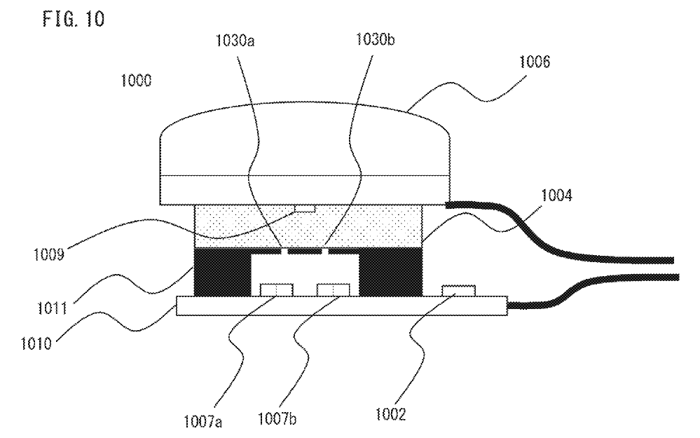

FIG. 10 is a diagram illustrating a configuration of another sensor unit 1000 used in the present example. The sensor unit 1000 is an optical tactile sensor.

The sensor unit 1000 is configured to include a circuit board 1010 on which quadrant photodiodes 1007a and 1007b and an inertia sensor IC 1002 are mounted, an elastic member 1004, a light-emitting element 1009, and a contact member 1006. The inertia sensor IC 1002 has an embedded detection unit for a 3-axis acceleration and a 3-axis angular velocity. The contact member 1006 is a member that comes into contact with skin.

Between the circuit board 1010 and the contact member 1006, an opening member 1011 and the elastic member 1004 are disposed. The elastic member 1004 can be deformed by an external force applied between the contact member 1006 and the circuit board 1010.

On the contact member 1006 side of the elastic member 1004, the light-emitting element 1009 made of an LED is fixed. Each of the quadrant photodiodes 1007a and 1007b is a photo acceptance unit having a light-receiving surface that is vertically and horizontally divided into four segments. The opening member 1011 includes an opening 1030a and an opening 1030b in an optical path between the light-emitting element 1009 and the quadrant photodiodes 1007a and 1007b. The sensor unit 1000 uses outputs from the quadrant photodiodes 1007a and 1007b to detect a three-dimensional displacement of the light-emitting element 1009 via a subsequent signal processing circuit (not shown) and calculates the external force from the detected amount of displacement.

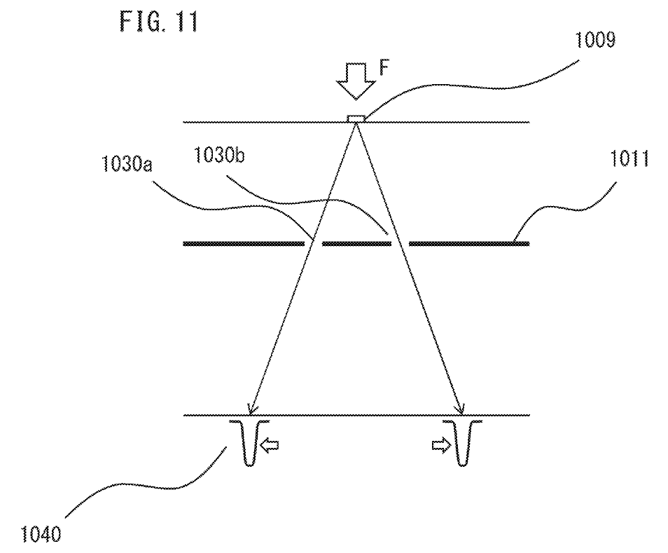

Referring to FIG. 11, a description will be given of a procedure of detecting an amount of movement of the light-emitting element 1009 due to the external force and calculating the external force. FIG. 11 is a schematic diagram illustrating a movement of the light-emitting element 1009 upon receipt of an external force in a perpendicular direction, and a movement of projected spots 1040. Depending on a ratio of a distance between the light-emitting element 1009 and each of the opening 1030a and the opening 1030b to a distance between each of the opening 1030a and the opening 1030b and a light-receiving IC surface, a distance between the pair of spots formed by the one light-emitting element 1009 varies. When receiving a force pushing the light-emitting element 1009 in a surface direction, the light-emitting element 1009 moves in a downward direction, and the distance between the light-emitting element 1009 and each of the opening 1030a and the opening 1030b is reduced. As a result, a distance between the centers of the pair of spots is increased. Conversely, when receiving a force pulling the light-emitting element 1009 in the surface direction, the light-emitting element 1009 moves in an upward direction, and the distance between the light-emitting element 1009 and each of the opening 1030a and the opening 1030b is increased. As a result, the distance between the centers of the pair of spots is reduced.

The sensor unit 1000 can estimate the external force in the perpendicular direction by calculating distances between coordinates of the center positions of the pair of spots.

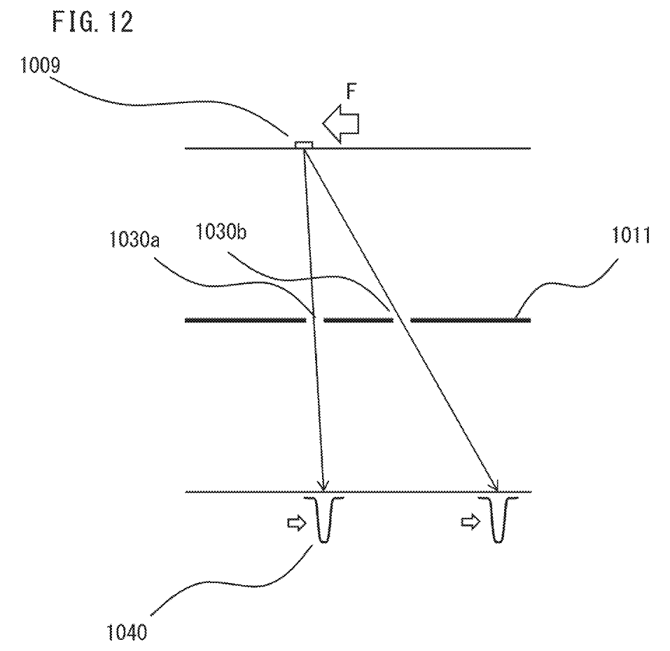

FIG. 12 is schematic diagram illustrating a movement of the light-emitting element 1009 when receiving an external force in a shear direction, and a movement of the projected spots 1040. When the elastic member 1004 receives the external force in the shear direction via the contact member 1006, the light-emitting element 1009 moves in an in-plane direction. As a result, the centers of the center positions of the pair of spots move in directions opposite to the external force. By calculating an average value of the center position coordinates of the pair of spots, it is possible to estimate the external force in the shear direction. Since each of the divided photodiodes 1007a and 1007b has a light-receiving portion divided into the four segments, the sensor unit 1000 can estimate a two-dimensional external force in the in-plane direction.

The first biometric information detection unit 701 and the second biometric information detection unit 702 are pressed against and under the cheek and chin of the user. By bringing the first biometric information detection unit 701 and the second biometric information detection unit 702 into contact with the skin of the user, it is possible for the first biometric information detection unit 701 and the second biometric information detection unit 702 to detect the biometric information.

The transmission/reception unit 703 is connected to the first biometric information detection unit 701 and the second biometric information detection unit 702. The transmission/reception unit 703 can transmit the biometric information detected by the first biometric information detection unit 701 and the second biometric information detection unit 702 to the outside. In addition, the transmission/reception unit 703 can also acquire information from a smartphone 805. The biometric information detected by the first biometric information detection unit 701 and the second biometric information detection unit 702 is wirelessly transferred to the smartphone 805 by using the transmission/reception unit 703.

The reception unit 806 in an application of the smartphone 805 receives the biometric information detected by the first biometric information detection unit 701 and the second biometric information detection unit 702. The determination unit 812 determines whether the received biometric information corresponds to a specific motion for controlling the smartphone on the basis of a trained model. For example, when the determination unit 812 determines that the biometric information corresponds to a nodding motion, the smartphone 805 transfers a result of the determination to the detection device 100 via the data transfer unit 807 and the transmission/reception unit 703. The sound information output units 704 produce a sound to notify the user that the estimation of biometric information is to be started, while the data transfer unit 807 transfers the biometric information to a cloud 811. An estimation unit 808 on the cloud 811 starts estimation from the biometric information to the voice information using the trained model. The estimation unit 808 continues the estimation until the determination unit 812 determines that the user has not moved his or her mouth for 1 second or longer. When the estimation unit 808 is notified by the determination unit 812 that there is no mouth movement for 1 second or longer, the estimation unit 808 ends the estimation processing.

When it is determined by the determination unit 812 that the biometric information detected from one or more portions of the user corresponds to any of the specific movements for performing the system control, the system control unit 813 performs the system control corresponding to the movement.

In the present example, the same trained model is used to determine a predetermined movement for the system control and to estimate the voice information or textual information from the biometric information. The trained model was generated as follows. First, biometric information during silent vocalization was acquired from five users for 20 motions in addition to 5,000 sentences. Then, 80% of all data was used as training data, while the remaining 20% thereof was used as evaluation data. For the training, the training data was used to train a neural network 2000 epochs, thus producing the trained model.

The voice information resulting from conversion by the estimation unit 808 is transferred to the data transfer unit 807. The voice information resulting from the conversion by the estimation unit 808 is transferred to another smartphone 810 to be reproduced. At the same time, the voice resulting from the conversion is transferred to a transmission/reception unit via the data transfer unit 807. The transferred voice is reproduced via the sound information output units 704, such as earphones, and the user confirms a result of the conversion.

### Other Examples

Each of the above examples is merely an example of the information processing system according to the present disclosure, and can be modified as appropriate within the scope of the concept of the present disclosure.

For example, in the above description, the detection devices of the neckband type, the neckband-earphone combination type, and the headset type are shown by way of example, but the detection devices may also be an eyeglass type, a mask type, a jaw mask type, a choker type, a ring type, and the like. In the case of a ring-type device, when inputting to the system is to be performed, the device is pressed against a portion such as a face.

In addition, the biometric information to be used for the estimation the textual information or voice information and input determination for the system control is not limited to the specific examples described above. The information processing according to the present disclosure may also use any biometric information, as long as the biometric information can be acquired from a portion of the user. By way of example, biometric information related to movements of an arm, a leg, a chest region, or an abdominal region may also be acquired. Moreover, the detection of the biometric information may also be performed by using a sensor other than permanent sensors and, for example, it may also be possible to capture an image by using a camera and use, as the biometric information, a movement of a body part of the user that is obtained by image analysis.

Furthermore, while the information processing system configured to include the detection device and the information processing apparatus has been shown by way of example, the information processing system may also be configured to include another device, or may also be an integral system in which the detection device and the information processing apparatus are included in one device.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, in an information processing system that converts biometric information to textual information or voice information, it is possible to easily control a device without using another device.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An information processing system comprising:
a processor; and
a memory storing a program which, when executed by the processor, causes the information processing system to execute
a biometric information detection processing of detecting biometric information from one or more portions of a user;
an estimation processing of estimating textual information or voice information from the biometric information detected by the biometric information detection processing;
a determination processing of determining whether or not the biometric information corresponds to a specific movement for controlling the system; and
a control processing of controlling the system on the basis of a result of the determination by the determination processing.

2. The information processing system according to claim 1,
wherein, when it is determined that the biometric information corresponds to a first specific movement, in the control processing the system is controlled so as to start the estimation of the textual information or the voice information by the estimation processing based on the biometric information.

3. The information processing system according to claim 1,
wherein, when it is determined that the biometric information corresponds to a second specific movement, in the control processing the system is controlled so as to end the estimation of the textual information or the voice information by the estimation processing based on the biometric information.

4. The information processing system according to claim 1,
wherein in the control processing the system is controlled so as to switch an operation mode depending on which one of a plurality of the specific movements the biometric information corresponds to.

5. The information processing system according to claim 1,
wherein in the control processing the system is controlled so as to activate an application depending on which one of the plurality of specific movements the biometric information corresponds to.

6. The information processing system according to claim 1,
wherein the specific movement is at least any one of a face movement, a cheek movement, a tongue movement, and an eyeball or eyelid movement of the user.

7. The information processing system according to claim 1,
wherein in the biometric information detection processing the biometric information for estimating the voice information or the textual information and the biometric information for determining whether or not the biometric information corresponds to the specific movement are detected by using a same sensor.

8. The information processing system according to claim 1,
wherein in the biometric information detection processing at least one of an acceleration sensor and an angular velocity sensor is used and a myoelectric sensor is used.

9. The information processing system according to claim 1,
wherein in the biometric information detection processing at least one of an acceleration sensor and an angular velocity sensor is used and a tactile sensor is used.

10. The information processing system according to claim 1,
wherein in the biometric information detection processing the biometric information is detected from at least two or more portions of the user among the user's lower jaw region, cheeks, throat, subaural regions, neck region, and temples.

11. The information processing system according to claim 1,
wherein in the control processing displaying the textual information by using a display is started when it is determined that the biometric information corresponds to a third specific movement, and the displaying of the textual information using the display is ended when it is determined that the biometric information corresponds to a fourth specific movement.

12. The information processing system according to claim 1,
wherein in the control processing outputting the voice information by using a sound information output processing is started when it is determined that the biometric information corresponds to a fifth specific movement, and the outputting of the voice information using the sound information output processing is ended when it is determined that the biometric information corresponds to a sixth specific movement.

13. The information processing system according to claim 1,
wherein in the estimation processing the textual information or the voice information is estimated from the biometric information by using a first trained model, and
wherein in the determination processing it is determined whether or not the biometric information corresponds to the specific movement by using a second trained model.

14. The information processing system according to claim 13,
wherein each of the first trained model and the second trained model is a same trained model.

15. The information processing system according to claim 1,
wherein the biometric information detection processing is executed in a device that can be attached to the user, and
wherein the estimation processing, the determination processing, and the control processing are executed in an information processing apparatus configured to be communicative with the device.

16. The information processing system according to claim 15,
wherein the device outputs the textual information or the voice information estimated by the estimation processing.

17. The information processing system according to claim 1,
wherein in the control processing the system is controlled on the basis of a type of a movement based on the biometric information.

18. An information processing method comprising:
detecting biometric information from one or more portions of a user;
estimating textual information or voice information from the biometric information detected in the detecting;
determining whether or not the biometric information corresponds to a specific movement for controlling a system; and
controlling the system on the basis of a result of the determination in the determining.

19. A non-transitory computer readable medium that stores a program, wherein the program causes a computer to execute an information processing method comprising:
detecting biometric information from one or more portions of a user;
estimating textual information or voice information from the biometric information detected in the detecting;
determining whether or not the biometric information corresponds to a specific movement for controlling a system; and
controlling the system on the basis of a result of the determination in the determining.
